(19) United States
(12) Patent Application Publication
(10) Pub. No.: US 2011/0319509 A1
(43) Pub. Date: Dec. 29, 2011

(54) POLYMER COMPOSITES INCORPORATING STEREOCOMPLEXATION

(75) Inventors: John R. Dorgan, Golden, CO (US); Birgit Braun, Pearland, TX (US)

(73) Assignee: Polynew, Inc., Golden, CO (US)

(21) Appl. No.: 13/070,378

(22) Filed: Mar. 23, 2011

Related U.S. Application Data
(60) Provisional application No. 61/316,758, filed on Mar. 23, 2010.

(51) Int. Cl. C08L 67/04; C08J 9/35; C08L 1/08

(52) U.S. Cl. 521/81; 525/54.3; 521/134; 525/450; 524/539

(57) ABSTRACT

Grafting polymer chains onto filler particles is an established methodology for creating superior polymer composite materials. Stereocomplexation is a non-bonded interaction between polymers that leads to a crystalline form having a higher melting temperature than the non-stereocomplexed form; stereocomplexed polymers often have superior properties compared to their non-stereocomplexed constituents. The present application discloses combining grafted filler particles with matrix materials in which the grafted polymer layer forms a stereocomplex with the polymer matrix. The resulting composite materials have properties which exceed both filled polymer systems and stereocomplexed polymers.

### CROSS-REFERENCE TO RELATED APPLICATIONS

The present application is a nonprovisional application which claims priority from the U.S. Provisional Patent Application No. 61/316,758, filed 23 Mar. 2010, entitled “Polymer Composites Incorporating Stereocomplexation,” the subject matter of which is hereby being specifically and entirely incorporated herein by reference for all that it discloses and teaches.

### GOVERNMENT INTEREST

This development was made with government support under National Science Foundation, Grant No. IIP-0822999. The government has certain rights in the development.

### FIELD

The developments relate to polymer composites and more particularly, the developments include novel methods of making filled polymeric composites and nanocomposites having desirable physical characteristics.

### BACKGROUND

An established route to improving the physical properties of a chosen polymer is through the introduction of mineral and non-mineral fillers such as glass or cellulose. Generally, improvements are best provided by good dispersion of the filler throughout the polymer matrix and controlled interfacial adhesion between the filler and polymer matrix. Filling methods can also be very cost effective if the filling agents are of moderate cost.

Purely physical mixing of fillers into a polymer has shown successful improvements in mechanical properties by the formation of biocomposites (Mohanty, A. K., Misra, M., Drzal, L. T., Sustainable Bio-Composites from Renewable Resources: Opportunities and Challenges in the Green Materials World. Journal of Polymers and the Environment, 10, No. 1/2: 19-26, Apr. 2002). Biobased fibers including kenaf, hemp, jute, sisal, henequen, pineapple leaf, etc. can be incorporated into degradable, biodegradable, and nondegradable polymers. Flax fibers (30-40 wt %) were embedded into a polylactic acid (PLA) matrix by Oksman et al. (Oksman, K., M. Skrifvars, and J. F. Selin, Natural fibres as reinforcement in polylactic acid (PLA) composites. Composites Science and Technology, 63(9):1317-1324, 2003) who then compared the resulting composite properties to polypropylene (PP) filled with the same fibers. Promising properties of the flax-PLA composites were found; the composite strength was about 50% greater compared to similar flax-PP composites that are industrially employed. However, a lack of interfacial adhesion between the polymer matrix and the fiber surface was suggested by microscopy studies. Improvement of the tensile strength, tensile modulus and impact strength upon reinforcing PLA with cellulose fibers has been observed (Huda, M. S., et al., Effect of processing conditions on the physico-mechanical properties of cellulose fiber reinforced poly(lactic acid). ANTEC 2004 Plastics: Annual Technical Conference, Volume 2: Materials, 2:1614-1618, 2004; Huda, M. S., et al. Physico-mechanical properties of “Green” Composites from poly(lactic acid) and cellulose fibers, at GPEC, Detroit, USA, 2004). However, the introduction of cellulose fibers did not affect the glass transition temperature significantly as measured by DSC. However, such microcomposites are not transparent and also have various challenges associated with processing into useful parts including usually having to add an anti-microbial agent. An additional limitation of these filled systems is that their properties are dependent on the level of polymer crystallinity achieved in the matrix material.

The limitations associated with microcomposites have led to the development of polymer nanocomposites. In such materials, at least one dimension of the filler material is of a size from 1 to 100 nanometers. Nanocomposites comprised of polylactide as the matrix have been developed (Bhardwaj, R., Mohanty, A. K., Advances in the Properties of Polylactides Based Materials: A Review, Journal of Biobased Materials and Bioenergy, 1: 191-209, 2007). Commonly used nanoscopic fillers (nanofillers) are clays and other mineral fillers. While clay filled nanocomposites of polylactides have been extensively studied (Ray, S. S., Bousmina, M., Biodegradable polymers and their layered silicate nanocomposites: In greening the 21^{st} century materials world, Progress in Materials Science 50: 962-1079, 2005), filling of plastics with these ammonium ion containing clays renders them unsuitable for food packaging due to toxicity and other considerations; decomposition of the ammonium ions leads to the production of ammonia during processing of the plastics into useful items. Additionally, clays are mined materials which are not renewable. Ideally, bioplastic nanocomposites should be based on renewable nanofibers in the same manner that a biocomposite is comprised of a biofiber embedded in a bioplastic. This has led a number of researchers to consider the use of cellulosic nanofibers as reinforcing agents for plastics and bioplastics; also the surfaces of the cellulosic fibers can be modified in order to obtain better dispersion and interfacial adhesion (Samir MASA, Alloin F, Dufresne A. Review of Recent Research into Cellulosic Whiskers, Their Properties and Their Application in Nanocomposite Field. Biomacromolecules 6: 612-26, 2005). Recent developments using various forms of microcrystalline and nanoscopic cellulose have considerable prior art associated with them. However, while well dispersed nanocomposites can maintain transparency, the composite properties (in particular the heat distortion temperature, HDT) are dependent on the level of crystallinity achieved.

Thus, there is a desire for improved polymer composites and for an improved method of making these filled polymers to achieve the desired polymer physical characteristics rapidly and at an acceptable cost.

A stereocomplex is a non-bonded association between polymers having different tacticitites or configurations. Stereocomplexation is documented for, but not limited to, the following examples: 1) isotactic and sydiotactic polymers, like vinyl polymers including poly(methyl methacrylate) (T. G. Fox, B. S. Garrett, W. E. Goode, S. Gratch, J. F. Kincaid, A. Spell, J. D. Stroupe, Crystalline Polymers of Methyl Methacrylate. Journal of the American Chemical Society, 80: 1768-1769, 1958), 2) between polymers possessing a chiral center in the backbone, like polyesters such as poly(L-lactic acid) and poly(D-lactic acid) (H. Tsuji, Poly(lactide) Stereocomplexes: Formation, Structure, Properties, Degradation, and Application. Macromolecular Bioscience, 5: 569-597, 2005), and 3) between polymers having a chiral center in a side chain, such as optically active methacrylamides with L- and D-leucine moieties (F. Sanda, M. Nakamura, T. Endo, Syntheses and Radical Copolymerization Behavior of Optically Active Methacrylamides Having L- and D-Leucine Moieties. Interaction Between L- and D-Forms. Macromolecules, 29: 8064, 1996). However, stereocomplexation can also occur between polymers with different chemical structures, like between syndiotactic poly(isobutyl methacrylate) and isotactic poly(methyl methacrylate).

Stereocomplexation occurs between oligomers or polymers under a variety of conditions including in solution, in the bulk or melt state, during polymerization, or during degradation. Stereocomplexes are comprised of blends of homopolymers, or non-blended block-copolymers comprised of blocks of both stereoforms, or their mixtures.

Properties of stereocomplexes can exceed those of the individual polymers. For example, stereocomplexes can exhibit higher melting temperatures than semicrystalline polymers containing one stereoform. Enhanced heat resistance and improvements in mechanical properties are demonstrated for stereocomplexes of poly(D-lactic acid) and poly(L-lactic acid) (H. Tsuji, Poly(lactide) Stereocomplexes: Formation, Structure, Properties, Degradation, and Application. Macromolecular Bioscience, 5: 569-597, 2005).

Fillers can serve as nucleating agents which enhance crystallization rates and therefore the amount of achievable crystallinity in economically practicable manufacturing processes. Grafting of a polymer chain onto fillers through covalent bonding can further enhance the nucleating capabilities of the filler. Resulting composite materials comprised of a polymer-grafted-filler embedded in a polymer matrix can have significantly improved thermophysical properties. Similarly, polymer mixtures comprised of stereocomplexed polymers can have improved physical properties. While both of these effects are known, their combined use to create a polymer-grafted filler embedded in a matrix with which stereocomplexation is possible has not been previously reported. This unobvious combination yields a new class of materials with sought after properties.

### SUMMARY

Novel polymer composites and novel methods of making polymer composites are disclosed. These methods produce polymer composites in an economically efficient and environmentally friendly manner. The technologies disclosed herein relate to polymer composite materials in which polymers capable of forming stereocomplexes are present. In an implementation, a polymer composite material comprising mixtures of polymer grafted fillers, homopolymers, and copolymers that form one or more stereocomplexes is made. The resulting polymer composites made through these methods have desirable thermal and physical properties.

Methods are utilized to graft polymer chains onto the surfaces of filler materials. A method hereof may be a method of preparing a composite comprising creating a polymer grafted filler by chemisorption, physisorption, or a combination of chemisorption and physisorption; combining said polymer grafted filler with a matrix of homopolymers, copolymers, impact modifiers, flow modifying agents, foaming agents, and pigments which is capable of forming one or more stereocomplexes with the polymer grafted filler; and processing the resulting composite material to realize stereocomplexation, further comprising producing the composite continuously or in batches through the use of a particle size reducer and a stirred tank reactor, dispersing filler and creating polymer grafted filler with said reactor, staging the reactor to feed into an extruder in which reaction, mixing, and devolatilization occur; and adding into the matrix of stereocomplex forming polymer, one or more of impact modifier, stabilizers, additives, and pigments. Said methods may involve covalent attachment through chemical reaction (chemisorption) or physical adsorption onto the surface (physisorption) based on interactions including, but not limited to, electrostatics, dispersion forces, hydrogen bonding, or combinations thereof. The fillers may be either organic in nature, including but not limited to cellulosic based particles and fibers, or mineral in nature, including but not limited to talc, clays, various glasses, or titanium dioxide. Filler particles may be of variable sizes from a few nanometers to hundred of microns in their minimum dimension. The grafted polymer chains are capable of forming stereocomplexes and may be either homopolymers, copolymers, or combinations thereof. The composite material is comprised of polymer grafted fillers embedded in a polymer matrix in which stereocomplexation takes place. In one implementation, the composite is comprised of particles or fibers with poly(D-lactic acid) grafted to the surface embedded in a matrix containing poly(L-lactic acid). In another implementation, the composite is comprised of particles or fibers with poly(L-lactic acid) grafted to the surface embedded in a matrix containing poly(D-lactic acid). In another implementation, the grafted layer can include mixtures of the homopolymers of poly(L-lactic acid) and poly(D-lactic acid) embedded in a matrix of mixtures of the homopolymers of poly(L-lactic acid) and poly(D-lactic acid). In another implementation, the grafted layer can include block copolymers of D-lactic acid and L-lactic acid embedded in a matrix of block copolymers of D-lactic acid and L-lactic acid. In another implementation the grafted layer may be comprised of mixtures of homopolymers of poly(L-lactic acid), homopolymers of poly(D-lactic acid), copolymers of D-lactic acid, and copolymers of L-lactic acid embedded in a matrix of mixtures of homopolymers of poly(L-lactic acid), homopolymers of poly(D-lactic acid), copolymers of D-lactic acid, and copolymers of L-lactic acid. In implementations utilizing PLA, both ring opening polymerization of lactide or condensation of lactic acid or combinations thereof can be used to form the polymer layer grafted to the filler or in the matrix. Physisorption of polymer onto the particles may also be utilized as a means of forming the grafted layer as can the combination of physisorption with covalent chemical attachment. In another implementation the particles are microcrystalline cellulose or particles containing cellulose derived from biomass. Composites can further include said mixtures and functionalized polymers of cellulose including, but not limited to, cellulose acetate, cellulose butyrate, cellulose propionate, methyl cellulose, ethyl cellulose, and poly(D-lactic acid)-graft-cellulosic copolymers. Furthermore, the composites can be formulated to include impact modifying agents including, but not limited to, Dupont Biomax Strong 120 ethylene copolymer, BASF Ecoflex degradable copolymer, and Rhom and Haas Paraloid BPM 500. Another implementation includes the use of nucleating agents that assist polymer crystallization and flow additives, including but not limited to polyethylene glycol esters. Finally, the composites may be comprised of isotactic and sydiotactic poly(methyl methacylate) or other polymer structures capable of forming stereocomplexes.

### BRIEF DESCRIPTION OF THE TABLES

TABLE 1
Thermo-physical properties as measured by DSC for composites synthesized using ring
opening polymerization of DD-lactide in solution to form the grafted layer on the filler.

| | | | | | Homocrystals | | | Stereocrystals | | | Total |
|---|---|---|---|---|---|---|---|---|---|---|---|
| | PDLA | PLLA | CNW | Tg | Tm | ΔH | Crystallinity | Tm | ΔH | Crystallinity | Crystallinity |
| Sample ID | [wt %] | [wt %] | [wt %] | [° C.] | [° C.] | [J/g] | [%] | [° C.] | [J/g] | [%] | [%] |
| PLLA | 0.0 | 100.0 | 0.0 | 58.7 | 172.2 | 50.3 | 54.1 | 0.0 | 0.0 | 0.0 | 54.1 |
| PDLA | 100.0 | 0.0 | 0.0 | 59.2 | 173.6 | 44.4 | 47.8 | 0.0 | 0.0 | 0.0 | 47.8 |
| PLLA/PDLA | 50.0 | 50.0 | 0.0 | 60.7 | 167.6 | 10.9 | 11.7 | 224.6 | 60.8 | 42.8 | 54.5 |
| CNW-g-PLLA | 0.0 | 85.0 | 15.0 | 52.3 | 167.3 | 48.7 | 61.6 | 0.0 | 0.0 | 0.0 | 61.6 |
| CNW-g-PLLA/PDLA | 46.5 | 46.5 | 7.0 | 60.9 | 0.0 | 0.0 | 0.0 | 225.0 | 74.0 | 56.0 | 56.0 |

TABLE 2
Thermo-physical properties as measured by DSC for composites synthesized using
condensation polymerization of lactic acid to form the grafted layer on the filler.

| | | | | | Homocrystals | | | Stereocrystals | | | Total |
|---|---|---|---|---|---|---|---|---|---|---|---|
| | PDLA | PLLA | CNW | Tg | Tm | ΔH | Crystallinity | Tm | ΔH | Crystallinity | Crystallinity |
| Sample ID | [wt %] | [wt %] | [wt %] | [° C.] | [° C.] | [J/g] | [%] | [° C.] | [J/g] | [%] | [%] |
| PLLA | 0.0 | 100.0 | 0.0 | 56.5 | 170.2 | 48.5 | 52.2 | 0.0 | 0.0 | 0.0 | 52.2 |
| CNW-g-PDLA (cond) | 0.0 | 86.4 | 13.6 | 32.7 | 151.0 | 35.1 | 43.7 | 0.0 | 0.0 | 0.0 | 43.7 |
| CNW-g-PDLA (cond)/PLLA | 46.4 | 46.4 | 7.3 | 44.3 | 0.0 | 0.0 | 0.0 | 208.4 | 54.7 | 41.6 | 41.6 |

TABLE 3
Thermo-physical properties as measured by DSC for composites of variable
composition synthesized using ring opening polymerization of LL-lactide in the bulk to form the
grafted layer on the filler.

| | | | | | Homocrystals | | | Stereocrystals | | | Total |
|---|---|---|---|---|---|---|---|---|---|---|---|
| | PDLA | PLLA | CNW | Tg | Tm | ΔH | Crystallinity | Tm | ΔH | Crystallinity | Crystallinity |
| Sample ID | [wt %] | [wt %] | [wt %] | [° C.] | [° C.] | [J/g] | [%] | [° C.] | [J/g] | [%] | [%] |
| 6.25% CNW-g-PDLA(rc) | 4.6 | 93.8 | 1.6 | 57.0 | 157.4 | 28.7 | 30.3 | 221.6 | 9.3 | 6.5 | 36.8 |
| 12.50% CNW-g-PDLA(rc) | 9.2 | 87.5 | 3.3 | 55.3 | 158.4 | 25.2 | 26.2 | 226.1 | 17.4 | 11.8 | 38.0 |
| 25.00% CNW-g-PDLA(rc) | 18.4 | 75.0 | 6.6 | 57.1 | 150.7 | 14.5 | 14.5 | 228.8 | 38.9 | 25.6 | 40.1 |
| 50.00% CNW-g-PDLA(rc) | 36.9 | 50.0 | 13.1 | 55.8 | 0.0 | 0.0 | 0.0 | 227.4 | 75.8 | 46.4 | 46.4 |

TABLE 4
Thermo-physical properties as measured by DSC for stereocomplex
containing composites demonstrating that the inclusion of grafted filler
produces higher degrees of crystallinity than an unfilled system.

| | | | | | Stereocrystals | | |
|---|---|---|---|---|---|---|---|
| | PDLA | PLLA | CNW | Tg | Tm | ΔH | Crystallinity |
| Sample ID | [wt %] | [wt %] | [wt %] | [° C.] | [° C.] | [J/g] | [%] |
| PLLA/PDLA | 50.0 | 50.0 | 0.0 | 60.7 | 224.6 | 60.8 | 42.8 |
| CNW-g-PLLA/PDLA | 46.5 | 46.5 | 7.0 | 60.9 | 225.0 | 74.0 | 56.0 |
| TiOx-PLLA/PDLA | 46.5 | 46.5 | 7.0 | 61.8 | 224.7 | 76.4 | 57.9 |

Table 1 summarizes the thermo-physical properties, as measured by differential scanning calorimetry (DSC), of poly(L-lactide) (PLLA), poly(D-lactide) (PDLA) and a cellulosic nanowhisker-graft-poly(L-lactide) (CNW-g-PLLA). Table 1 also presents properties for blends of these components. One blend includes 50 wt % PLLA with 50 wt % PDLA and exhibits a melting peak at 224.6° C. characteristic of the stereocomplex. The second blend is comprised of 46.5 wt % poly(D-lactide) and 53.5 wt % CNW-g-PLLA and exhibits a melting peak at 225.0° C. characteristic of the stereocomplex. This later blend is representative of one implementation of the novel composite materials comprising the present art. All synthetic polymer materials in Table 1 were prepared by ring opening polymerization of lactide using solution polymerization methods.

Table 2 summarizes the thermo-physical properties of blend components, as measured by DSC, for materials in which all synthetic polymers were synthesized using condensation polymerization methods applied to lactic acid. Properties for PLLA, CNW-g-PDLA, and a blend of these two components are given. The blend exhibits a melting temperature of 208.4° C. characteristic of the stereocomplex. This later blend is representative of one implementation of the novel composite materials comprising the present development.

Table 3 summarizes the thermo-physical properties for various blend compositions prepared by melt mixing. In these composite materials, the CNW-g-PDLA and PLLA materials were synthesized by ring opening bulk polymerization. All of the blends exhibit a melting temperature in excess of 220° C. characteristic of the stereocomplex. These blends are representative of one implementation of the novel composite materials of the subject disclosure.

Table 4 presents thermo-physical properties, as measured by DSC, of PLLA/PDLA blends with and without filler present. All blends show melting temperatures above 220° C. characteristic of the stereocomplex. The presence of the filler leads to higher degrees of stereocomplex crystallinity; PLLA/PDLA is about 42.8% crystalline, CNW-g-PLLA/PDLA is about 56.0% crystalline, and titanium oxide-grafted-PLLA (TiOx-g-PLLA)/PDLA is about 57.9% crystalline.

### BRIEF DESCRIPTION OF THE DRAWINGS

FIG. 1 shows Fourier Transform Infrared (FTIR) spectra, from top to bottom, of a) polylactide, b) acetylated cellulosic nanowhiskers, c) acetylated cellulose nanowhiskers with physisorbed polylactides after repeated washing with chloroform, and d) acetylated cellulose nanowhiskers with covalently attached polylactides after repeated washing with chloroform. The ratio of ester linkages to cellulosic repeat unit is higher for the covalently attached materials in d compared to the physisorbed materials in c thereby demonstrating successful chemical grafting.

FIG. 2 presents DSC heating scans from top to bottom of a) poly(L-lactide)/(poly(L-lactic acid), PLLA) showing a melting peak near 180° C., b) poly(D-lactide)/(poly(D-lactic acid), PDLA) showing a melting peak near 180° C., c) a 50 wt % PLLA/50 wt % PDLA blend exhibiting a stereocomplex melting peak near 230° C., d) PLLA grafted to cellulose nanowhiskers by covalent bonding using surface initiated polymerization of L-lactide (CNW-g-PLLA) showing a melting peak near 180° C., and e) a composite including of CNW-g-PLLA in a PDLA matrix showing a melting peak near 230° C. The nanocomposite of the polymer grafted cellulose nanowhisker (CNW-g-PLLA) dispersed in a polymer matrix containing PDLA clearly shows the melting peak at about 230° C. characteristic of stereocomplexation.

FIG. 3 shows FTIR spectra in the region between 975 and 845 cm⁻¹, from top to bottom, of a) poly(L-lactide) (poly(L-lactic acid), PLLA) showing absorbance characteristic of the homopolymer crystallites near 922 cm⁻¹, b) poly(D-lactide) (poly(D-lactic acid), PDL) showing absorbance characteristic of the homopolymer crystallites near 922 cm⁻¹, c) a 50% by weight blend of PLLA in PDLA showing absorbance characteristic of the stereocomplex crystallites near 908 cm⁻¹, d) PLLA grafted to cellulose nanowhiskers by covalent bonding using surface initiated polymerization of LL-lactide (CNW-g-PLLA) showing absorbance characteristic of the homopolymer crystallites near 922 cm⁻¹, and d) a nanocomposite including CNW-g-PLLA in a PDLA matrix showing absorbance characteristic of the stereocomplex crystallites near 908 cm⁻¹. The nanocomposite made up of the polymer grafted cellulose nanowhisker dispersed in a polymer matrix clearly shows the FTIR absorbance characteristic of stereocomplexation.

FIG. 4 shows polarized optical micrographs taken between crossed polarizers at 100× magnification at various temperatures depicting the crystallization behavior of a blend of PLLA and PDLA of low molecular weight (top) in comparison to a blend of CNW-g-PLLA and PDLA (bottom), namely, a) PLLA blended with PDLA of low molecular weight, and b) CNW-g-PLLA blended with PDLA. Crystallinity is persistent at 180° C. in the composite indicating stereocomplex formation.

FIG. 5 shows FTIR spectra, from top to bottom, of a) pure poly(L-lactide), b) cellulosic nanowhiskers after treatment with D-lactic acid and condensation polymerization to produce poly(D-lactic acid) (PDLA), and c) cellulosic nanowhiskers after treatment with D-lactic acid and condensation polymerization to produce poly(D-lactic acid), and repeated washing in chloroform. The persistence of polylactide signals in the spectrum after repeated washing demonstrates that the poly(D-lactic acid) synthesized from condensation reactions (CNW-g-PDLA (cond)) is grafted to the surface of the cellulosic filler.

FIG. 6 shows DSC heating scans, from top to bottom, of a) poly(L-lactide) (poly(L-lactic acid), PLLA) showing a melting peak near 180° C., b) Poly(D-lactic acid) (poly(D-lactide), PDLA) grafted to cellulose nanowhiskers synthesized by condensation polymerization of D-lactic acid (CNW-g-PDLA(cond)) showing a melting peak near 160° C., and c) a nanocomposite including CNW-g-PDLA(cond) in a PLLA matrix showing a melting peak at 220° C. characteristic of stereocomplexation.

FIG. 7 shows DSC heating scans of composites of variable composition containing PDLA grafted to cellulose nanowhiskers using surface initiated ring opening polymerization of D-lactide (CNW-g-PDLA(rc)) embedded in a matrix of PLLA. More specifically, FIG. 7 shows differential scanning calorimetry (DSC) heating scans of composites of variable composition containing PDLA grafted to cellulose nanowhiskers by covalent bonding using surface initiated ring opening polymerization of DD-lactide (CNW-g-PDLA(rc)) embedded in a matrix of PLLA. Scans are shown, from top to bottom, of a) a composite containing 6.25 weight percent CNW-g-PDLA(rc) exhibiting a melting peak of homopolymer crystallites near 170° C. and a smaller melting peak of stereocomplex crystallites near 230° C., b) a composite containing 12.50 weight percent CNW-g-PDLA(rc) exhibiting a melting peak of homopolymer crystallites near 170° C. and a smaller melting peak of stereocomplex crystallites near 230° C., c) a composite containing 25.00 weight percent CNW-g-PDLA(rc) exhibiting a melting peak of homopolymer crystallites near 170° C. and a larger melting peak of stereocomplex crystallites near 230° C., and d) a composite containing 50 weight percent CNW-g-PDLA(rc) exhibiting no evidence of a melting peak of homopolymer crystallites near 170° C. but a prominent melting peak of stereocomplex crystallites near 230° C. These results indicate that composites formed by the methods disclosed may contain both homopolymer crystallites and stereocomplex crystallites of varying amounts depending on the mixture compositions. All compositions show evidence of a melting peak above 220° C. characteristic of stereocomplexation.

### DETAILED DESCRIPTION

Several factors influence the physical properties of polymer composites. Among the most important are the level of both distributive and dispersive mixing as well as the interfacial adhesion between polymer and the filling agent (Nielsen, L. E., Landel, R. F., Mechanical Properties of Polymers and Composites, Marcel Dekker, New York, 1994). Briefly, the quality of polymer composites is affected by 1) the modulus and other thermophysical properties of the fillers and polymers employed, 2) the size and shape of the filler particles (for fibers, aspect ratio is an important consideration), 3) the total amount of filler used (measured for example, as filler volume fraction), 4) orientation of the embedded filler particles, 5) intimacy of mixing (distribution of the filler and dispersion of filler aggregates) of filler throughout the polymeric matrix, and 5) the interfacial adhesion between the filler particle surface and the surrounding matrix.

Because of the great importance of both interfacial adhesion and intimacy of mixing, many technologies have been developed to provide composites in which these properties are optimized. When a hydrophilic particle is mixed with a hydrophobic polymer, a lack of dispersion and interfacial adhesion is observed. These effects are often overcome through the use of a surface modifying agent. For example, in glass and mineral fillers the use of silane coupling agents is widely practiced and these coupling agents are available with a wide range of chemical functionalities that enable compatibilization with many different plastic materials. However, such coupling agents are based on nonrenewable resources, are often not biodegradable, can be noxious or toxic, and are relatively expensive. These and other drawbacks limit coupling agent applications in low cost articles such as food packaging. Additionally, when it is desired that the polymer composite be degradable, or biodegradable, or based on renewable resources existing technologies are lacking. Thus the present developments disclose fabricating effective fillers that are based on renewable resources, which are biodegradable, and which have effective surface functionalization that enables their compatibilization with plastics, especially with biodegradable plastics that are also based on renewable resources.

Here, specific methods are developed for realizing this goal when the filling agent is cellulose or other biomass based and biodegradable material or when the filling agent is a non-biodegradable mineral such as titanium dioxides. The methods described herein overcome problems associated with forming composites and produces composites with superior physical characteristics to those formed by conventional means. Specifically, methods for producing composites including fillers having grafted polymer chains which are capable of forming stereocomplexes are disclosed. In preferred implementations, the polymer employed is polylactide in the form of poly(L-lactic acid), poly(D-lactic acid), block copolymers of poly(L-lactic acid) and poly(D-lactic acid) or mixtures thereof and the fillers are biodegradable biomass based materials. In alternative implementations the filler is of mineral origin. In another implementation the polymer employed is poly(methyl methacrylate) in the form of isotactic poly(methyl methacylate), sydiotactic poly(methyl methacylate), block copolymers of isotactic poly(methyl methacylate) and sydiotactic poly(methyl methacylate), or mixtures thereof and the filler is either biomass or mineral based.

Plants possess a hierarchical organization in their structure. Crystalline regions of extended cellulose polymer chains exist in so-called microfibrils, which are further assembled into cell walls, films, and fibers. Additionally, certain microorganisms will produce cellulose in many forms. In conventional routes to so-called microcrystalline cellulose, acid hydrolysis (typically in sulfuric or hydrochloric acid) is followed by intensive shearing in some type of homogenizer. The resulting aqueous dispersions include mixtures of cellulosic particles ranging from the individualized microfibrils (also called cellulose nanowhiskers (CNW)) to agglomerates of microfibrils, to micron sized particles. Upon separation and drying, dispersion of any size fraction of the hydrophilic cellulose in a hydrophobic polymer is difficult to achieve.

The methods disclosed include creating functionalized microcrystalline cellulose in a one-step process through the use of a mixed acid system including lactic acid and hydrochloric acid acting on cotton, cotton linter, or other cellulosic containing material. The resulting mixture is subject to mechanical action by high speed mixing, sonication, homogenization via flow of the suspension through static mixers, or other means. Particle size reducing equipment including but not limited to grinders, high shear mixers, or other types of equipment may be employed. The resulting microcrystalline cellulose is surface functionalized via esterification reaction with lactic acid. This functionalized cellulose dispersed in lactic acid may be subject to conditions which result in poly(lactic acid) being formed by condensation polymerization reactions. Condensation catalysts include but are not limited to tin(II) chloride with and without variable amounts of toluene sulfonic acid as co-catalyst, stannous octoate, zinc chloride, germanium oxides, titanium butoxide and butylate, titatium isopropoxide and isopropylate, phosphoric acid, hydrochloric acid, sulfuric acid, mineral acid, dibutyltin dilaurate, antimony oxides, aluminium acetylacetonate and aluminum oxides. Alternatively enzymatic catalysts can be employed. Procedures using condensation reactions lead to mixtures having cellulose with a grafted polymer layer and free polymer chains which are not grafted to the cellulose. Condensation polymerizations generally involve removal of the water reaction product to facilitate polymer molecular weight growth. Accordingly, condensation polymerizations are performed under reduced pressures or alternatively by sparging the reaction mixture with an inert gas, including but not limited to air, nitrogen, argon, helium, or their mixtures. Condensation polymerizations are conducted at temperatures of between 100° C. to 150° C., more preferably in the range of 120° C. to 140° C. One preferred methodology involves a gradually increasing the temperature in stages: the material is held under vacuum at room temperature for about 4 hours, the temperature is then increased to 85° C. over 4 hours and then held there for 18 hours. Subsequently, the temperature was further raised to 120° C. and maintained at that temperature for 52 hours. This method is referred to as condensation polymerization and denoted by the suffix (cond) on sample identifiers.

Alternatively, the surface functionalized cellulose may be isolated by washing and drying. This washed and dried cellulose can be dispersed in molten lactide monomer or a solution of lactide monomer and polymerized through the use of stannous octoate or other catalyst systems. Preferred catalysts systems include stannous octoate, triphenylphospine, trisnonylphenylphosphate, and/or mixtures thereof. Ring opening polymerization of molten lactides using stannous octoate catalyst systems is performed at temperatures in the range of 90° C. to 280° C., more preferably in the range of 120° C. to 250° C., and most preferably in the range of 175° C. to 205° C. Unreacted lactide monomer may be removed by devolatilization or other means. Additionally, deactivation of the catalyst at the end of a specified reaction time may be used to ensure a controlled termination of the reaction and to provide stability against molecular weight changes during any subsequent processing steps. Procedures using ring opening reactions lead to mixtures having cellulose with a grafted polymer layer and free polymer chains which are not grafted to the cellulose. This method is referred to as reactive compatibilization and denoted by the suffix (rc) on sample identifiers.

In one implementation, the preparation method involves dispersing the filler in a melt of lactide monomer followed by ring opening polymerization in the presence of stannous octoate to produce a polylactide grafted filler which is then contacted with poly(acrylic acid) or other compounds for stabilization. This polymer grafted filler is subsequently combined with other polymer grafted fillers, homopolymers, or copolymers to yield a composite capable of forming one or more stereocomplexes.

In one implementation, the preparation method involves dispersing the filler in a solution of lactide monomer in toluene or other solvent followed by ring opening polymerization in the presence of stannous octoate to produce a polylactide grafted filler which is then contacted with poly(acrylic acid) or other compound for stabilization. This polymer grafted filler is subsequently combined with other polymer grafted fillers, homopolymers, or copolymers to yield a composite capable of forming one or more stereocomplexes.

An alternative implementation for the preparation of the grafted polymer filler includes methods according to US Patent Application US2008/0118765 A1 (Sustainable Polymeric Nanocomposites). In these methods, the composite is prepared by lactide polymerization in the presence of a filler. These methods include the formation of a premix of the filler with initiating surface groups in lactide followed by polymerization using stannous octoate, triphenylphosphite, or other catalysts. Alternatively, high molecular weight polymer may be present in conjunction with a compatibilization agent, such as a transesterification catalyst. This polymer grafted filler is subsequently combined with other polymer grafted fillers, homopolymers, or copolymers to yield a composite capable of forming one or more stereocomplexes.

The resulting polymer grafted filler is subsequently mixed with other grafted fillers, polylactide homopolymers, or polylactide copolymers so that stereocomplexation occurs. The result is a biobased and biodegradable polymer composite including filler having a grafted polymer layer dispersed in a polymer matrix that forms stereocomplexes upon cooling from the fully molten state. These composites may include cellulosic particles of variable sizes from a few nanometers to hundred of microns in their minimum dimension. Composites can further include mixtures of chemically treated cellulose with stereocomplex forming polylactides to which functionalized polymers of cellulose including, but not limited to, cellulose acetate, cellulose butyrate, cellulose propionate, methyl cellulose, ethyl cellulose, and polylactide-graft-cellulosics are added. Furthermore, the composites can be formulated to include impact modifying agents including, but not limited to, Dupont Biomax Strong 120 ethylene copolymer, BASF Ecoflex degradable copolymer, and Rhom and Haas Paraloid BPM 500.

Methods of attachment of polymeric chains to the filler surface prior to blending with polymer matrix include mixing of monomer, oligomers, or polymers with the filler followed by polymerization (including but not limited to ring-opening or condensation polymerization), or chemical coupling (including but not limited to silane coupling agents, cyanides, titanium complexes and compounds, acid catalysts, base catalysts, salts of amino acids, and enzyme transesterification catalysts), or physisorption of polymer. Additionally, mixtures of monomers, oligomers, and high-molecular weight polymers in various ratios with and without catalysts present can be used to form the polymer grafted filler. Subjection of fillers to consecutive polymerizations alternating between monomers of differing stereoforms or the use of specialized stereospecific catalysts may be used to form grafted stereo-block-copolymers. These and other techniques can be used to create polymer grafted fillers in which the grafted polymer layers have controllable molecular weights, molecular architectures, and stereochemical compositions.

In these methods, the filler may be an organic filler, such as wood fiber, wood flour, starch without pretreatment, starch nanocrystals or other forms of starch derived by chemical modification, cellulose fibers, cellulosic nanowhiskers, cellulosic nanofibers, straws, bagasse, coconut hull/fiber, cork, corn cob, corn stover, cotton fibers, gilsonite, nutshell, nutshell flour, rice hull, sisal, hemp, kenaf, or soy bean, with and without pretreatments. The cellulose used in the preparations can be from a wide variety of sources including, but not limited to cotton, tunican, ash, poplar, recycled fiber, wood flour, straws, bagasse, coconut hull/fiber, cork, corn cob, corn stover, gilsonite, nutshell, nutshell-flour, rice hull, sisal, hemp, kenaf, or soybean. Cellulose obtained from microorganisms may also be employed. Alternatively, the filler may be carbon black, carbon fibers, buckminsterfullerene, carbon nanotubes, carbon nanoparticles, or synthetically prepared nanoparticles. Alternatively, molecular scale fillers such as polyols, glycols, other multifunctional alcohols and mixtures thereof may be employed. In a preferred implementation, the filler is cellulose derived from cotton or cotton linters.

In one implementation, a method for preparing the cellulosic filler is accomplished by suspending cotton or cotton linter in lactic acid (either D-lactic acid or L-lactic acid or a mixture of the two) using intensive mixing in a Waring blender and soaked overnight near room temperature. The resulting suspension is then heated to 105° C. whereupon hydrochloric acid (HCl) may be added to give a final acid concentration of about 2.5 M. This mixture may further be subjected to conditions favoring condensation polymerization to yield a material including cellulosic filler with grafted polylactide chains suspended in a polylactide matrix.

In one implementation, a method for preparing the cellulosic filler is accomplished by suspending cotton or cotton linter in lactic acid (either D-lactic acid or L-lactic acid or a mixture of the two) using intensive mixing in a Waring blender and soaked overnight near room temperature. The resulting suspension is then heated to 105° C. whereupon hydrochloric acid (HCl) may be added to give a final acid concentration of about 2.5 M. Reaction is allowed to proceed for a defined time period under specified conditions of temperature and pressure, after which the suspension is quenched and centrifuged to remove the acid. This treated cellulose may be repeatedly washed and centrifuged or processed in a continuous centrifuge operation unit operation with the addition of wash water. Afterwards the treated cellulose is resuspended in water and subjected to intensive mixing in a Waring blender and diluted with DI water. The nanosized fraction of the treated cellulose may be isolated by repeated washing and centrifugation by replacing the initially clear supernatant with DI water until the supernatant remains turbid. Repeated cycles of recovering the supernatant, resuspension with intensive mixing, and centrifugation provides batches of a turbid supernatant suspension. The treated cellulose recovered both in the supernatant and as the centrifugation cake may be dried in a number of ways including but not limited to freeze drying, drying in a fluidized bed, or spray drying.

In another implementation, preformed microcrystalline cellulose such as Avicel may be suspended in lactic acid (either D-lactic acid or L-lactic acid or a mixture of the two) using intensive mixing in a Waring blender and soaked overnight near room temperature. The resulting suspension is then heated to 105° C. whereupon hydrochloric acid (HCl) is added to give a final acid concentration of about 2.5 M. This mixture may further be subjected to conditions favoring condensation polymerization to yield a material including cellulosic filler with grafted polylactide chains suspended in a polylactide matrix.

In another implementation, preformed microcrystalline cellulose such as Avicel may be suspended in lactic acid (either D-lactic acid or L-lactic acid or a mixture of the two) using intensive mixing in a Waring blender and soaked overnight near room temperature. The resulting suspension is then heated to 105° C. whereupon hydrochloric acid (HCl) is added to give a final acid concentration of about 2.5 M. Reaction is allowed to proceed for a defined time period, after which the suspension is quenched and centrifuged to remove the excess acid. This treated cellulose may be repeatedly washed and centrifuged or processed in a continuous centrifuge operation unit. The treated cellulose may be subjected to additional intensive mixing in a Waring blender during the washing and centrifugation processing. The nanosized fraction of the treated cellulose may be isolated by repeated washing and centrifugation by replacing the initially clear supernatant with DI water until the supernatant remains turbid. The treated cellulose recovered both in the supernatant and as the centrifugation cake may be dried in a number of ways including but not limited to freeze drying, drying in a fluidized bed, or spray drying.

Alternatively, the filler may be an inorganic filler, such as a mineral, calcium carbonate, montmorilonite, kaolin, titanium dioxide, alumina tryhydrate, Wollastonite, talc, silica, quartz, barium sulfate, antimony oxide, mica, magnesium hydroxide, calcium sulfate, feldspar, nepheline syenite, microspheres, carbon black, glass, glass fibers, carbon fibers, metallic particles, magnetic particles, buckminsterfullerene, silicas, synthetic silicates, or synthetically prepared nanoparticles, with and without surface modification. The resulting lactic acid treated filler mixture may further be subjected to conditions favoring condensation polymerization to yield a material including cellulosic filler with grafted polylactide chains suspended in a polylactide matrix.

The composite can also be prepared by dispersion of fillers in solutions of variable concentrations of lactic acid in water or other suitable solvents followed by condensation polymerization with and without catalyst. Condensation catalysts include but are not limited to tin(II) chloride with and without variable amounts of toluene sulfonic acid as co-catalyst, stannous octoate, zinc, zinc chloride, and other zinc compounds, germanium oxides, titanium butoxide and butylate, titatium isopropoxide and isopropylate, phosphoric acid, hydrochloric acid, sulfuric acid, mineral acid, mono- and di-butyl organotin compounds, antimony oxides, aluminium acetylacetonate and aluminum oxides. Alternatively, enzymatic catalysts may be employed.

The cellulose used in the above preparations can be from a wide variety of sources including, but not limited to cotton, tunican, ash, poplar, fiber, wood flour, straws, bagasse, coconut hull/fiber, cork, corn cob, corn stover, gilsonite, nutshell, nutshell-flour, rice hull, sisal, hemp or soybean. Cellulose from microorganisms may also be utilized. Alternatively, the filler may be starch based microspheres, carbon black, glass, glass fibers, carbon fibers, metallic particles, magnetic particles, montmorillonite, buckminsterfullerene, carbon nanotubes, carbon nanoparticles, silicas, cellulosic nanofibers, synthetic silicates or synthetically prepared nanoparticles. In a preferred implementation, the filler is cellulose derived from cotton or cotton linters.

Methods for composite preparation include mixing of matrix polymers of various molecular weights and streochemical compositions with the polymer grafted filler. Pre-formed polymer may be made by condensation polymerization reactions, by ring-opening polymerization reactions, or by combinations thereof. Polymerizations may be carried out with and without the presence of catalytic compounds. The polymer grafted filler can be dispersed by appropriate techniques, including but not limited to melt blending, solution blending, solid state shear mixing, or combinations thereof.

In another implementation, a method of mixing the treated cellulose with molten polylactide in the temperature range of 150° C. to 200° C., more preferably in the range of 160° C. to 180° C., to produce a composite material is provided. This method is referred to as melt mixing.

In another implementation, a method of mixing the treated cellulose with preformed polylactide through the use of a solvent, including but not limited to chloroform, at ambient or elevated temperatures is provided. This method is referred to as solution blending.

Other implementations include composite polymers made by the addition of functionalized polymers of cellulose including but not limited to, cellulose acetate, cellulose butyrate, cellulose propionate, methyl cellulose, ethyl cellulose, and poly(lactide-graft-cellulosic) copolymers. In this implementation, the composite may also include a transesterification catalyst meant to promote interchange reactions between various components present in the composite. Suitable catalysts of the interchange reactions include titanium(IV) isopropoxide (TIP), dibutyl tin oxide (DBTO), Mono-, di-, and tetraalkyl tin(IV) compounds, monobutyltin trichloride (BuSnCl₃), TBD (1,5,7-triazabiscyclo(4.4.0)dec-5-ene), acid catalysts like sulfonic and sulfuric acids, base catalysts like sodium methylate, sodium methoxide, potassium methoxide, sodium hydroxide and potassium hydroxide, organic bases like triethylamine, piperidine, 1,2,2,6,6-pentamethylpiperidine, pyridine, 2,6-di-tert-butylpiridine, 1,3-disubstituted tetrakis(fluoroalkyl)distannoxanes, 4-dimethyl-aminopyridine (DMAP) and guanidine, alkaline metal alkoxides and hydroxides, basic zeolites and related solid compounds such as cesium—exchanged NaX faujasites, mixed magnesium-aluminum oxides, magenesium oxide and barium hydroxide, 4-(dimethylamino)pyridine (DMAP), 4-pyrrolidinopyridine (PPY), salts of amino acids, and enzyme transesterification catalysts. In the preferred implementation titanium(IV) isopropoxide is the interchange reaction catalyst employed.

Other implementations include composite polymers made by the addition of impact modifying agents. Significant increases in heat distortion temperatures may be obtained with simultaneous addition of an impact modifying agent. Impact modifying agents including but not limited to Dupont Biomax Strong 120 ethylene copolymer, Dupont Biomax Strong 100 ethylene copolymer, Arkema Biostrength 130 acrylic polymer, Arkema Biostrength 150 methacrylate-butadiene-styrene copolymer, Chemtura Blendex 338 acrylonitrile-butadiene-styrene copolymer, BASF Ecoflex degradable polyester copolymer, and Rhom and Haas Paraloid BPM 500 functionalized polymer or their mixtures may be employed. Alternatively, the impact modifier may be a mineral filler like Specialty Minerals EM Force Bio.

Other implementations include composite polymers made by the addition of various nucleating agents including but not limited to magnesium silicate, calcium carbonate, or calcium sulfate.

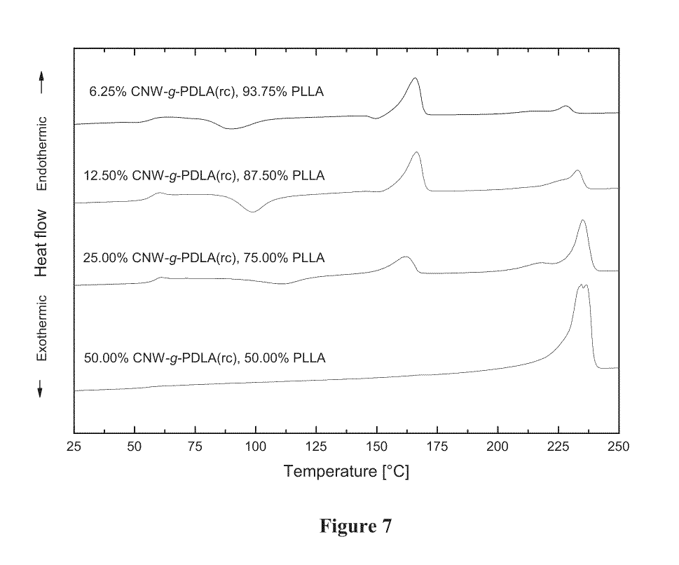

In another implementation, flow modifiers including but not limited to polyethylene glycol esters (mono- or di-esters of a fatty acid or oil reacted with a polyethylene glycol). In the preferred implementation PEG-150 such as BASF MAPEG 6000 DS derived from renewable resources is used in an amount between 0.1 and 5.0 wt %. These flow agents may be combined with impact modifying agents including but not limited to BASF Ecoflex degradable polyester copolymer, Dupont Biomax Strong 120 ethylene copolymer, Dupont Biomax Strong 100 ethylene copolymer, Arkema Biostrength 130 acrylic polymer, Arkema Biostrength 150 methacrylate-butadiene-styrene copolymer, Chemtura Blendex 338 acrylonitrile-butadiene-styrene copolymer, and Rhom and Haas Paraloid BPM 500 functionalized polymer. FIG. 7 presents the values for the impact strength of polylactide combined with BASF Ecoflex copolymer and BASF MAPEG 6000 DS polyethylene glycol esters. In the preferred implementation impact modifying polymers in an amount of about 0.5 wt % to 20 wt % are combined with polyethylene glycol esters in the amount of about 0.1% to 10%, more preferable are impact modifying polymers in the range of 2 wt % to 15 wt % and polyethylene glycol esters in the amount of 0.5 wt % to 3.5 wt %. Alternatively, the impact modifier may be a mineral filler like Specialty Minerals EM Force Bio.

Mixing of the reagents during polymerization, melt mixing, or solution blending is typically applied through a controlled mechanical means such as a commercial reactor, mixing device, or extruder; the extruder may have a static mixer attached.

After the polymerization reactions and/or mixing of components have been terminated, the composite polymers formed by the methods of the present development are preferably processed into a commercially desirable form such as pellets through cutting or grinding procedures (including underwater pelletizing). Alternatively, polymer composites formed in suspension using suitable liquids may be used directly in the form of beads for producing solid and foamed articles.

Additional objects, advantages, and novel features of this development will become apparent to those skilled in the art upon examination of the following examples. Those of ordinary skill in the art will readily understand that these examples are not limiting on the development as defined in the claims which follow.

### EXAMPLES

### Example 1

### Preparation of CNW-G-PLLA by Solution Polymerization and Combination with PDLA Using Solvent Assisted Mixing

L-lactide and D-lactide were dried under vacuum (22 inch Hg) at 50° C. for at least 8 hours prior to use. PLLA and PLDA were dried under vacuum (25 inch Hg) at 110° C. for at least 12 hours before being used. Alternatively, drying by conventional methods using dessicated air or other gas passed over the materials to be dried can be practiced. Acetic and hydrochloric acid, and reagent grade solvents were obtained from Sigma-Aldrich and used without further purification. Stannous octoate was distilled under reduced pressure, and solutions in anhydrous toluene prepared immediately before each reaction. Both the poly(acrylic acid) (PAA—molecular weight of about 2,000 g/mol) used for catalyst deactivation and microcrystalline cellulose (Avicel® PH-101) were also purchased from Sigma-Aldrich.

Cellulosic nanocrystals (CNW) were isolated from microcrystalline cellulose. A fraction of the accessible surface hydroxyl groups was acetylated to control the number of surface hydroxyl groups capable of initiating polymerization. Control of the initiator concentration on the surface of the filler enables control of the molecular weight of the grafted PLA chains. Acetylation was performed by Fischer esterification at 95° C. for 2 hrs using 90 wt % acetic acid with a catalytic amount of hydrochloric acid (0.027M). Subsequent mechanical disintegration was achieved using a Waring laboratory blender. Partially acetylated cellulosic nanowhiskers (CNW) were isolated by repeated centrifugation and freeze dried.

Freeze dried CNW were vacuum dried at 80° C. for 24 hrs to remove adsorbed moisture and then individualized and suspended in anhydrous toluene by sonication. The resulting suspension was added to pre-dried LL-lactide (0.28 g/mL) and stirred to create a homogeneous suspension. The polymerization catalyst stannous octoate was added at a ratio of R=2500 monomer molecules per catalyst molecule. The polymerization was conducted at 90° C. for 68 hrs. Subsequently, poly(acrylic acid) (PAA) was added. The nanocomposite material (CNW-g-PLLA) was isolated by precipitation into excess methanol and dried at 60° C. under vacuum.

Covalent attachment of the PLA chains onto the CNW surface was verified by Fourier-transform infrared spectroscopy of the solids recovered after twice washing CNW-g-PLLA in chloroform and separating free chains by centrifugation at 8,600 G for 40 min. A drop of the recovered suspension was allowed to dry on a KBr pellet, and the sample analyzed using a DTGS detector. The signal was compared to a control experiment in which the CNW suspension in toluene was added to pre-formed PLLA at the same ratio, and the mixture stirred at 90° C. for 68 hours. The solid fraction was separated from chains that did not physisorb to the CNW surface by centrifugation after washing with chloroform twice.

Poly(D-lactide) was prepared by solution polymerization in toluene at 90° C. for 68 hours with stannous octoate as catalyst (R=2500). PAA was added to deactivate the catalyst before precipitation into excess methanol. Molecular weights were determined by single point measurements of the dilute solution viscosity in chloroform at 30° C. Intrinsic viscosities were calculated using the Schulz-Blaschke equation (kSB=0.302+/−0.005). Weight-average molecular weights were determined from the Mark-Houwink equation (K=0.0153+/−0.0048, a=0.759+/−0.031), and converted to number-average molecular weights assuming a polydispersity index of 1.25.

Blends of CNW-g-PLLA and PDLA were prepared by solution blending in chloroform at a concentration of 5 wt % after stirring the individual components for a minimum of 8 hrs prior to combining solutions. After brief stirring, the material was precipitated by drop wise addition to excess methanol.

The formation of the stereocomplex between grafted PLLA chains and free PDLA chains was verified by differential scanning calorimetry, Fourier-transform infrared spectroscopy, and polarized optical microscopy. A Perkin Elmer DSC-7 after calibration against Indium and establishment of a baseline was used with the following temperature profile: 1) heat from 5 to 220° C. at 10° C./min, 2) hold at 220° C. for 3 min, 3) quench from 220 to 140° C. at 50° C./min, 4) hold at 140° C. for 30 min, 5) cool from 140 to 5° C. at 50° C./min, 6) heat from 5° C. to 250° C. at 10° C./min. Glass transition temperature (Tg), melting temperature (Tm), and percent crystallinity were determined from data obtained on the second heating cycle. FT-IR was performed on films cast onto KBr pellets before and after annealing at 140° C., which facilitates stereocomplex formation. Films deposited onto a glass slide were examined using an optical microscope at 100× while heated using a hot stage according to: 1) heat to 250° C., 2) cool to 140° C. at 20° C./min and hold for 60 min, 3) heat to 180° C. at 20° C./min and hold for 3 min, 4) heat to 250° C. at 20° C./min.

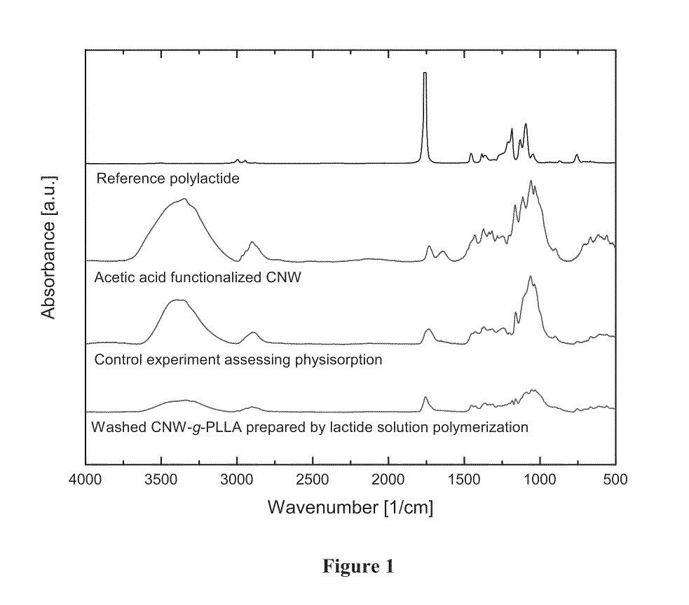

Fourier-transform infrared-spectroscopy (FT-IR) spectra presented in FIG. 1 are all normalized to the ester peak centered at 1736 cm⁻¹. Peak heights of the hydroxyl signal (OH signal) associated with cellulose are centered at 3400 cm⁻¹. The OH signal is absent for pure PLLA but OH groups on the surface and internal to the CNW are detected for surface modified CNW; the ratio of the ester signal to the OH peak is 0.24 for these samples. A slight increase in the ratio of the ester signal to the OH peak for the control experiment to a value of 0.34 suggests physisorption of PLLA onto the CNW surface. For CNW-g-PLLA, the ester to OH signal ratio is 1.43 or about 6 times higher compared to surface treated CNW and 4 times higher when compared to the physisorption control experiment. Accordingly, the FT-IR spectra verifies chemisorption (covalent attachment) to the filler surface.

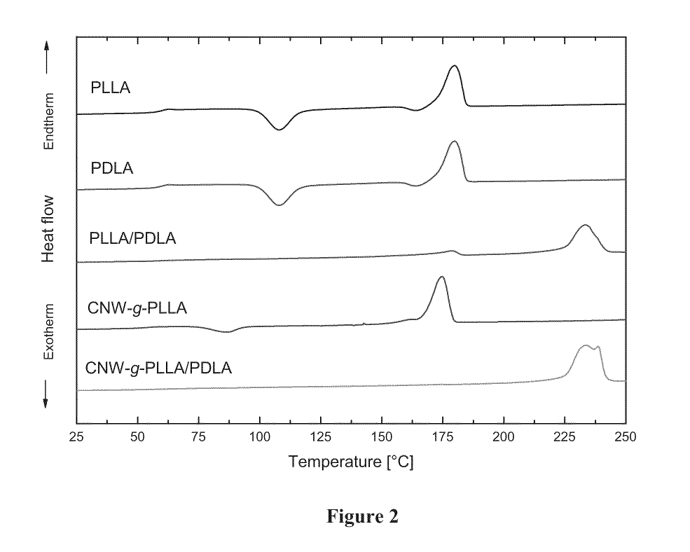

For comparison, a 50 wt %/50 wt % blend of PLLA and PDLA of a molecular weight of 132 kg/mol and 123 kg/mol, respectively, was prepared and analyzed. As shown in FIG. 2, melting peaks corresponding to homocrystallites (melting temperatures between 165 and 175° C.) are found for the blend components. However, a new melting peak appears for the blend with an onset temperature of 225° C.; this peak is clearly indicates the formation of the stereocomplex. Similarly, only the melting peak corresponding to homocrystallites is recorded for CNW-g-PLLA by itself. However, when CNW-g-PLLA is mixed with PDLA a high melting temperature is also observed verifying successful stereocomplex formation between the grafted poly(L-lactide) chains with free PDLA chains of the composite matrix.

Table 1 summarizes the thermophysical properties of the components and their resulting blends. The formation of the stereocomplex between grafted PLLA and free PDLA chains results in a 5° C. increase of the glass transition temperature over the theoretical prediction from the Gordon-Taylor Tg mixing rule for compatible polymer blends but no such effect is observed for the unfilled stereocomplex system. Additionally, an increase in the overall extent of crystallinity is observed for the filled system (42.8% for the unfilled blend, compared to 56.0% for the blend containing CNW-g-PLLA).

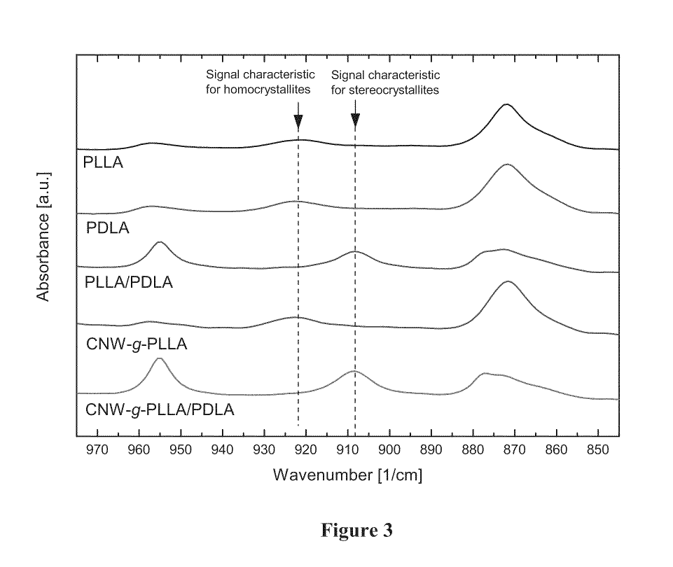

The formation of the stereocomplex for the CNW-g-PLLA/PDLA blend was independently verified by FT-IR after annealing of films cast from solutions at 140° C. for 30 min. Spectra are shown in FIG. 3. The signal at 923 cm⁻¹ is characteristic for PLLA and PDLA homocrystallites and is present in the individual blend components after annealing. However, this peak is absent in PLLA/PDLA and CNW-g-PLLA/PDLA blends. Instead a peak centered at 908 cm⁻¹ confirms the different crystal structure present in the stereocomplex for both blends. (Zhang, J., Sato, H., Tsuji, H., Noda, I., Ozaki, Y. Infrared Spectroscopic Study of CH3 . . . O═C Interaction during Poly(L-lactide)/Poly(D-lactide) Stereocomplex Formation. Macromolecules, 38: 1822-1828, 2005).

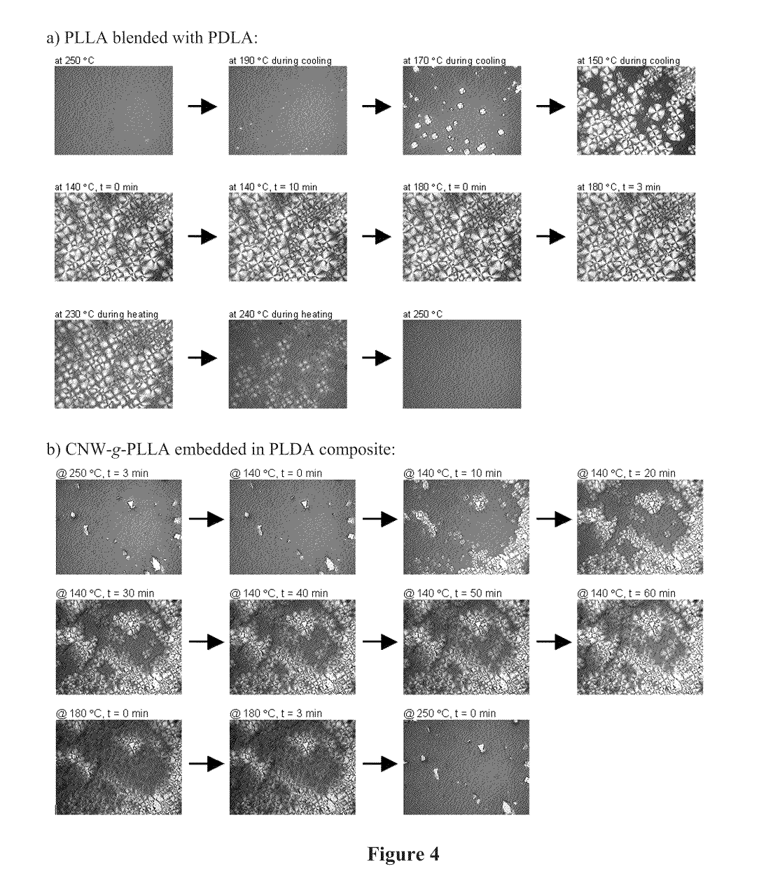

The presence of stereocrystallites was also visually demonstrated by polarized optical microscopy at a magnification of 100× using a heating stage. For illustration and comparison, a 50/50 w/w blend of PLLA and PDLA is shown in the top part of FIG. 4; the formation of stereocrystals after quenching from the melt to 140° C. is rapid. The presence of stereocomplex crystals rather than homocrystals is demonstrated by the direct observation that the crystallites persist at 180° C. and do not melt until 240° C. Similar observations are demonstrated for the CNW-g-PLLA/PDLA blend; crystallites remain intact upon heating to 180° C. but disappear once a temperature of 250° C. is reached.

The above example is representative and not limiting regarding the claimed development. In particular, the D-enantiomer (D-lactide) and L-enantiomer (L-lactide) may serve in opposite roles. That is, a CNW-g-PDLA may be synthesized and embedded in a PLLA and the stereocomplex will also be formed. Similarly, mixtures of CNW-g-PDLA and CNW-g-PLLA can be embedded in a matrix including homopolymers and copolymers of L-lactide, D-lactide, and meso-lactide and stereocomplexation will be realized.

### Example 2

### Preparation of CNW-G-PDLA by Condensation Polymerization and Combination with Commercially Available PLA Using Solvent Assisted Mixing

85 wt % D-lactic acid in water was obtained from Purac. Hydrochloric acid and reagent grade solvents were obtained from Sigma Aldrich, as were stannous chloride and p-toluene sulfonic acid. All chemicals were used without further purification. Commercially available poly(lactide) copolymer (a copolymer of L-lactide, D-lactide, and meso-lactide which is predominantly composed of L-lactide (96%)) was obtained from NatureWorks LLC (Grade 2000D, molecular weight of 110 kg/mol as determined by dilute solution viscometry), and used as received.

Cellulosic nanocrystals (CNW) were isolated from microcrystalline cellulose (Avicel® PH-101) purchased from Sigma by sonication at 6 wt % in 85 wt % acetic acid overnight. Fischer esterification of surface hydroxyl groups during sonication was facilitated by the presence of a catalytic amount of hydrochloric acid (0.027M).

Stannous chloride with an equimolar amount of p-toluene sulfonic acid and 0.5 wt % Irganox/Irgafos for chemical stabilization was added to the mixture prior to condensation under vacuum. The condensation polymerization was performed in stages. The first stage was conducted at room temperature for 4 hrs under moderate vacuum to remove the free water present in the 85% D-lactic acid solution. Subsequently, the temperature was increasing to 85° C. over a period of 4 hrs and then held at this temperature for 18 hrs. The temperature was then raised to 120° C. and maintained for 52 hrs. The resulting supramolecular species is referred to as CNW-g-PDLA(cond) to indicate it is synthesized by condensation polymerization.

Covalent attachment of the PLA chains onto the CNW surface was verified by Fourier-transform infrared spectroscopy of the solids recovered after twice washing the material recovered from the condensation reaction in chloroform and separating free chains by centrifugation at 8,600 G for 40 min. A drop of the recovered suspension was allowed to dry on a KBr pellet, and the sample analyzed using a DTGS detector.

Composites of CNW-g-PLLA(cond) and NatureWorks PLA were prepared by solution blending in chloroform. Individual components were stirred for a minimum of 8 hours at a concentration of 5 wt % to ensure complete dissolution prior to combining the two solutions. After stirring, the material was precipitated by drop wise addition to excess methanol.

The formation of the stereocomplex between grafted CNW-g-PDLA(cond) and Natureworks PLA copolymer was verified by differential scanning calorimetry. A Perkin Elmer DSC-7 after calibration against Indium and establishment of a baseline was used with the following temperature profile: 1) heat from 5 to 220° C. at 10° C./min, 2) hold at 220° C. for 3 min, 3) quench from 220 to 140° C. at 50° C./min, 4) hold at 140° C. for 30 min, 5) cool from 140 to 5° C. at 50° C./min, 6) heat from 5° C. to 250° C. at 10° C./min. Tg, Tm and amount of crystallinity were determined from data obtained on the second heating cycle.

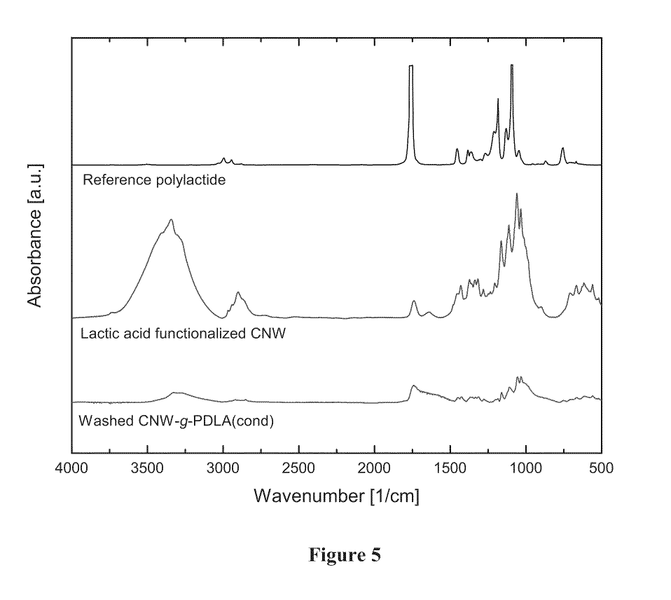

The FT-IR spectra shown in FIG. 5 compare poly(lactide), CNW isolated after Fischer esterification with lactic acid, and the solid fraction recovered after repeated washes of the condensation product CNW-g-PDLA(cond). The CNW spectra are normalized to the ester peak centered at 1736 cm⁻¹. Peak heights of the hydroxyl signal (OH signal) centered at 3400 cm⁻¹ clearly indicate successful covalent attachment of PDLA chains for the CNW-g-PDLA(cond) samples. The ratio of the ester signal to the OH peak for CNW after esterification is 0.17. By comparison, for the CNW-g-PDLA(cond) the value increases ten fold to a value of 1.73. This result clearly verifies successful covalent attachment of polymer chains onto the filler surface. Also, compared to lactide solution polymerization in the presence of the filler, this ratio is higher due to the greater number of available initiators on the filler surface due to the absence of a pretreatment to reduce surface hydroxyls (as per acetylation in solution polymerization reactions). The molecular weight of the resulting chains is lower with about 2.5 kg/mol as determined by glass transition measurements.

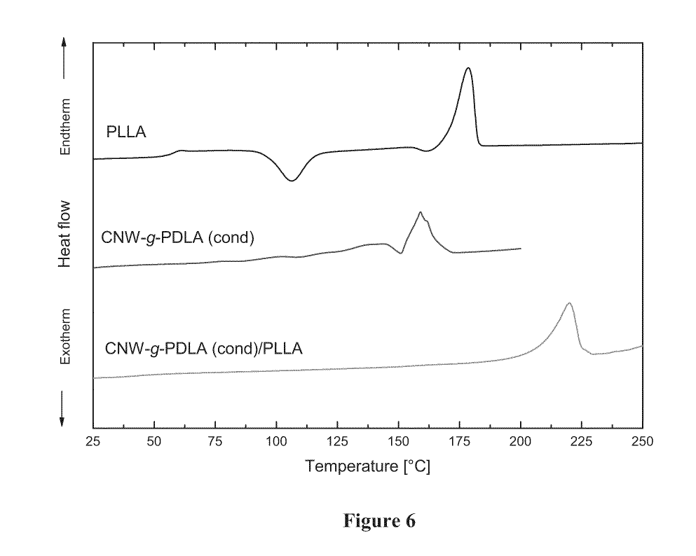

The DSC heating scans shown in FIG. 6 only exhibit a melting peak corresponding to homocrystallites for the individual components NatureWorks PLA and CNW-g-PDLA(cond). However, combination of the two components results in a material that only displays a melting peak with an onset temperature of 208° C. for the stereocrystallites. The lower onset temperature for the stereocrystallites is likely caused by the lower molecular weight of the polymeric chains grafted to the filler surface. Table 2 summarizes the thermophysical properties of the components and their resulting blends. The glass transition temperature of the blend is again higher than the theoretically expected value of 41.4° C. (predicted based on mixing rule). The above results clearly demonstrate that condensation polymerization onto a cellulosic substrate produces a materials capable of engaging in stereocomplexation with free chains of the opposite stereoform despite lower molecular weights and higher grafting densities.

The above example is representative and not limiting regarding the claimed art. In particular, the D-enantiomer (D-lactic acid) and L-enantiomer (copolymer made up predominantly of L-lactide) may serve in opposite roles. That is, a CNW-g-PLLA(cond) may be synthesized and embedded in a copolymer predominantly made up of D-lactide and stereocomplexes will be formed. Similarly, mixtures of CNW-g-PDLA(cond) and CNW-g-PLLA(cond) can be embedded in a matrix including homopolymers and copolymers of L-lactide, D-lactide, and meso-lactide and stereocomplexation will be realized.

### Example 3

### Preparation of CNW-g-PLLA by Melt Polymerization and Combination with Combination with Commercially Available PLA Using Melt Mixing

Dispersion of native or modified cellulosic nanowhiskers in lactide followed by polymerization may be achieved following the procedure outlined in US Patent Application US2009/0118765 A1 Sustainable Polymeric Nanocomposites.

D-lactide was obtained from Purac and used as received. Crystals were dried at room temperature under vacuum (25 in Hg) for a minimum of 48 hrs prior to use. Reagent grade solvents were obtained from Sigma Aldrich and used without further purification. Stannous octoate was distilled under reduced pressure, and solutions in anhydrous toluene prepared immediately before each reaction. Poly(acrylic acid) (PAA) for catalyst deactivation was of a molecular weight of 2,000 g/mol and also purchased from Sigma. Commercially available poly(lactide) copolymer (a copolymer of L-lactide, D-lactide, and meso-lactide which is predominantly composed of L-lactide (96%)) was obtained from NatureWorks LLC (Grade 2000D, molecular weight of 110 kg/mol as determined by dilute solution viscometry) and used as received after drying at 110° C. for 12 hrs prior to use. Alternate drying by conventional methods using desiccated air or other gas passed over the materials to be dried may be practiced.

Cellulosic nanocrystals (CNW) were isolated from microcrystalline cellulose (Avicel® PH-101) purchased from Sigma. Break-up and dispersion in the lactide monomer was achieved in a Warning laboratory blender fitted with a heating mantle, thermocouple, and temperature controller. Molten lactide was introduced to the blender at a temperature of 95 to 110° C., cellulose gradually added and the mixture subjected to intensive mixing by blending for about 20 min in the presence of a stabilizer to minimize lactide degradation. The monomer in this mixture may be polymerized directly through addition of a suitable catalyst. Alternatively, this pre-lactide-CNW mixture may be pulverized after cooling, dried and stored to be used when desired.

Polymeric nanocomposites with chains covalently attached to the filler surface were prepared from lactide-CNW mixtures during melt mixing in a Haake Rheomix 3000 batch mixer. The batch mixer operated at 25 r.p.m. Once the mixture reached a melt temperature of 180° C., stannous octoate was added as catalyst, and the reaction allowed to proceed for 30 min. After the specified reaction time, poly(acrylic acid) was added at a concentration of 0.25 wt % relative to the lactide mass and blended with the composite for about a minute to deactivate the catalyst. Other additives including stabilizers, impact modifying agents, and pigments may also be added by melt mixing. The material was removed from the mixer, allowed to cool, and pelletized in a Foremost grinder to a maximum particle size of about 2 to 3 mm in diameter. Unreacted monomer was removed by drying under vacuum at 120° C. for 48 hrs under vacuum. The resulting material, derived in this reactive compatibilization methodology, is denoted CNW-g-PDLA(rc). It is a stable compound that can be stored until desired for use in further processing or article manufacture.

Composites were fabricated by melt blending of CNW-g-PDLA(rc) with NatureWorks PLA. The individual components were dried at 80° C. under vacuum for 24 hrs in the presence of a chemical stabilization package (Irganox/Irganfos mixture of 0.25 wt % each relative to total polymer mass). Melt mixing was conducted in a Haake Rheomix 600. The mixing protocol was as follows: 1) PLA addition to the mixing bowl at a rotor speed of 50 rpm and a temperature set point of 210° C., 2) addition of stabilizer, 3) reduction of the temperature set point to 205° C., 4) addition of the CNW-g-PDLA(rc), 5) blending at 50 rpm for 5 min, followed by an increase of the mixing speed to 100 rpm for 5 min. Composites of various mixture compositions were prepared, allowed to cool, and pelletized in a Foremost grinder.

The formation of the stereocomplex between CNW-g-PDLA with NatureWorks PLA was verified by differential scanning calorimetry. A Perkin Elmer DSC-7 after calibration against Indium and establishment of a baseline was used with the following temperature profile: 1) heat from 5 to 250° C. at 10° C./min, 2) cool from 250 to 5° C. at 5° C./min, and 3) heat from 5° C. to 250° C. at 10° C./min. Tg, Tm and amount of crystallinity were determined from data obtained on the first heating cycle to examine the material properties as received after blending.

DSC heating scans for various blend compositions are shown in FIG. 7. As the content of CNW-g-PDLA(rc) increases, the melting peak for the stereocrystallites at temperatures above 220° C. becomes more pronounced, indicating an increasing amount of stereocomplex is present. For a composite containing roughly equal amounts of the two stereoforms (50/50 w/w blend) no homocrystallite melting peaks (usually present at 155 to 160° C.) are detected.

Table 3 summarizes the thermophysical properties of the composites prepared by melt mixing.

The above example is representative and not limiting regarding the claimed development. In particular, the D-enantiomer (D-lactide) and L-enantiomer (copolymer made up predominantly of L-lactide) may serve in opposite roles. That is, a CNW-g-PLLA(rc) may be synthesized and embedded in a copolymer predominantly made up of D-lactide and stereocomplexes will be formed. Similarly, mixtures of CNW-g-PDLA(rc) and CNW-g-PLLA(rc) can be embedded in a matrix made up of homopolymers and copolymers of L-lactide, D-lactide, and meso-lactide and stereocomplexation will be realized. In an alternative embodiment, the polymer composite may be created in the form of beads via a suspension polymerization utilizing an appropriate suspending medium.

### Example 4

### Preparation of TiOx-Graft-PLLA by Solution Polymerization and Combination with PDLA Using Solvent Assisted Mixing

L- and D-lactide were obtained from Purac and re-crystallized from ethyl acetate. Crystals were dried at 50° C. under vacuum (25 in Hg) for a minimum of 48 hrs prior to use. Titanium(IV) oxide (rutile mineral) with an average particle size less than 50 μm was purchased from Sigma Aldrich and dried under vacuum at 120° C. before use. Reagent grade solvents were also obtained from Sigma Aldrich and used without further purification. Stannous octoate was distilled under reduced pressure and solutions in anhydrous toluene prepared immediately before each reaction. Poly(acrylic acid) (PAA) for catalyst deactivation was of a molecular weight of 2,000 g/mol and also purchased from Sigma Aldrich.

Titanium(IV) oxide (TiOx) particles were dispersed in anhydrous toluene by sonication overnight. The suspension was added to pre-dried L-lactide (0.28 g/mL). Stannous octoate was added as polymerization catalyst at a ratio of R=2500 monomer molecules per catalyst molecule. The polymerization was conducted at 90° C. for 68 hrs before PAA addition. The composite material was isolated by precipitation into excess methanol and dried at 60° C. under vacuum.

The form of the TiOx-g-PLLA was found to be that of a physisorbed layer of polymer chains on the mineral surface. Thermogravimetric analysis after repeated washing of the composite in chloroform and isolation of the solid fraction by centrifugation was performed. Upon heating in air the composite did not show a mass loss at the temperature characteristic for polylactide but rather resembled the mass loss as a function of temperature for unmodified TiOx. Accordingly, repeated washing with chloroform was able to remove the PLLA from the TiOx indicating that chemisorption did not occur.

Poly(D-lactide) was prepared by solution polymerization in toluene at 90° C. for 68 hrs with stannous octoate as catalyst (R=2500). PAA was added to deactivate the catalyst before precipitation into excess methanol.

Composites of TiOx-PLLA and PDLA were prepared by solution blending in chloroform. Individual components were stirred at a concentration of 5 wt % for a minimum of 8 hrs to ensure complete dissolution prior to combination of the solutions. After stirring, the composite material was precipitated by drop wise addition to excess methanol, collected and dried at 60° C. under vacuum.

Differential scanning calorimetry verified stereocomplex formation. Thermophysical properties are summarized in Table 4. Importantly, the achievable extent of crystallinity is higher when fillers are present, indicating that they may serve as nucleation agents. The total extent of crystallinity is about 10% higher for filled systems than simple homopolymer blends of the opposite stereoform.

The above example is representative and not limiting regarding the claimed development. In particular, the D-enantiomer (D-lactide) and L-enantiomer (copolymer made up predominantly of L-lactide) may serve in opposite roles. That is, a TiOx-g-PLLA may be synthesized and embedded in a copolymer predominantly made up of D-lactide and stereocomplexes will be formed. Similarly, mixtures of TiOx-g-PDLA and TiOx-g-PLLA can be embedded in a matrix made up of homopolymers and copolymers of L-lactide, D-lactide, and meso-lactide and stereocomplexation will be realized. Additionally, physisorption can be realized in the melt phase, without the use of solvents.

The foregoing description of the present developments has been presented for purposes of illustration and description. Furthermore, the description is not intended to limit the developments to the form disclosed herein. Consequently, variations and modifications commensurate with the above teachings, and the skill or knowledge of the relevant art, are within the scope of the present developments. The implementations described herein above are further intended to explain the best mode known for practicing the development and to enable others skilled in the art to utilize the development in such, or other, implementations and with various modifications disclosed by the particular applications or uses of the present developments. It is intended that the appended claims be construed to include alternative implementations to the extent permitted by the prior art.

What is claimed is:

1. A polymer composite material comprising mixtures of polymer grafted fillers, homopolymers, and copolymers that form one or more stereocomplexes.

2. A composite prepared by a method comprising:
a. Creating a polymer grafted filler by chemisorption, physisorption, or a combination of chemisorption and physisorption;
b. Combining said polymer grafted filler with a matrix of homopolymers, copolymers, impact modifiers, flow modifying agents, foaming agents, and pigments which is capable of forming one or more stereocomplexes with the polymer grafted filler; and
c. Processing the resulting composite material to realize stereocomplexation.

3. A composite according to claim 2 in which one or more of the composite is produced continuously or in batches through the use of a particle size reducer and a stirred tank reactor to disperse filler and create polymer grafted filler with said reactor staged to feed into an extruder in which one or more of reaction, mixing, and devolatilization occur and in which the matrix of stereocomplex forming polymer, one or more of impact modifiers, stabilizers, additives, and pigments are added.

4. A composite according to claim 1 in which the fillers are fractionated by size using one or more of centrifugation, membrane separation, filtration, field flow fractionation, or chromatography.

5. A composite according to claim 1 to which are added one or more of ethylene and propylene copolymers, degradable copolymers, poly(lactide-co-isoprene) copolymers, and acrylate copolymers.

6. A composite according to claim 1 in which the fillers are treated with one or more of a mixture including of D-lactic acid, L-lactic acid, D-lactide, L-lactide, and meso lactide to create a polylactide-graft-cellulose embedded in a matrix including the copolymer of L-lactide, D-lactide, and meso-lactide capable of forming a stereocomplex to form a resulting composite.

7. A composite according to claim 6 in which the resulting composite is contacted with one or more of poly(acrylic acid), amines, phosphates, or antioxidants to form a melt stabilized polymer composite.

8. A composite according to claim 6 in which the fillers are biodegradable and include one or more of cellulose, hemicellulose, lignin, starch, chitin, proteins, polyols, glycols, or multifunctional alcohols

9. A composite according to claim 8 wherein the cellulose is one or more of cellulose acetate, cellulose butyrate, cellulose propionate, methyl cellulose, and ethyl cellulose.

10. A composite according to claim 6 in which the fillers are non-biodegradable and include one or more of titanium dioxide, talc, calcium carbonate, calcium oxide, apatite, carbon nanotubes, carbon nanostructures, metallic particles, magnetic particles, gold, silver, copper, iron, aluminum, gadolinium, metallic oxides, carbides, and alloys.

11. A composite according to claim 6 in which the composite is produced continuously through the use of a particle size reducer and a continuously stirred tank reactor to disperse cellulose in mixtures comprised of lactic acid and lactide to create polymer grafted filler; said reactor staged to feed into an extruder in which the polymerization is completed and in which the matrix of stereocomplex forming polymer, one or more of impact modifier, stabilizer, additives, and pigments are added.

12. A composite according to claim 3 in which the extruder feeds one or more of a pelletizing die, a sheet die so as to produce a continuous sheet of desired width and thickness, and a profile shaping die.

13. A composite according to claim 8, wherein the cellulose is a particle larger than a nanometer sized particle.

14. A composite according to claim 8, wherein the cellulose is a particle larger than a micron sized particle.

15. A method of preparing a composite comprising:
a. Creating a polymer grafted filler by chemisorption, physisorption, or a combination of chemisorption and physisorption;
b. Combining said polymer grafted filler with a matrix of homopolymers, copolymers, impact modifiers, flow modifying agents, foaming agents, and pigments which is capable of forming one or more stereocomplexes with the polymer grafted filler; and
c. Processing the resulting composite material to realize stereocomplexation.

16. A method for producing a composite according to claim 15 further comprising:
producing the composite continuously or in batches through the use of a particle size reducer and a stirred tank reactor;
dispersing filler and creating polymer grafted filler with said reactor;
staging the reactor to feed into an extruder in which one or more of reaction, mixing, and devolatilization occur; and
adding into the matrix of stereocomplex forming polymer, one or more of impact modifier, stabilizers, additives, and pigments.

17. A method for producing a composite according to claim 16, further comprising:
producing the composite continuously through the use of a particle size reducer and a continuously stirred tank reactor to disperse cellulose in mixtures of lactic acid and lactide to create polymer grafted filler;
staging said reactor to feed into an extruder in which the polymerization is completed; and
adding into the matrix of stereocomplex forming polymer, one or more of impact modifier, stabilizer, additives, and pigments.

18. A method for producing a composite according to claim 16 in which the extruder feeds one or more of a pelletizing die, a sheet die so as to produce a continuous sheet of desired width and thickness, and a profile shaping die.
